(19) United States
(12) Patent Application Publication
(10) Pub. No.: US 2004/0027774 A1
(43) Pub. Date: Feb. 12, 2004

(54) Photothermal magnetic drive device driving method, potothermal magnetic drive device and production method for ni based alloy with low-temperature curie temperature using this

(76) Inventors: Hidekazu Takizawa, Nagano (JP); Mika Makimura, Nagano (JP); Shinichi Anzawa, Nagano (JP)

Correspondence Address: BIRCH STEWART KOLASCH & BIRCH, PO BOX 747, FALLS CHURCH, VA, 22040-0747, US

(21) Appl. No.: 10/399,914

(22) PCT Filed: Oct. 22, 2001
(86) PCT No.: PCT/JP01/09263

(30) Foreign Application Priority Data
Oct. 24, 2001 (JP) 2000-363873
Mar. 30, 2001 (JP) 2001-100298

(51) Int. Cl. H01H 47/00

(52) U.S. Cl. 361/143

(57) ABSTRACT

The present invention provides a photothermal magnetic drive device using a Ni based ally capable of controlling a Curie temperature (Tc) by means of a composition ratio at comparatively low costs and consisting of an easy-workable low-temperature Curie-temperature (Tc) material.

The photothermal magnetic drive device of the present invention is characterized by comprising a support (4) of a non-magnetic material supported rotatably, a plurality of heat-sensitive magnetic materials (1) disposed on the support (4) at intervals in the support's rotational direction and each consisting of a Ni based alloy (excluding NiFe alloys and NiFeCr alloys) having low-temperature Curie temperature, a magnet (2) disposed facing one of or a plurality of the heat-sensitive magnetic materials, for producing a magnetic field, and a heat collecting unit (8) for spot-controlling heat from a photothermal source to a position deviated from the magnetizing center, by the magnet (2), on the heat-sensitive magnetic material (1) facing the magnet (2).

### FIELD OF TECHNOLOGY

The present invention relates to a photothermal magnetic drive device driving method, a photothermal magnetic drive device and a production method for Ni based alloy with low-temperature Curie temperature using this.

### CONVENTIONAL TECHNOLOGY

A “photothermal motor”, which is driven by magnetic characteristics and variation of temperature, is known as an example of motors directly converting photothermal energy into mechanical action (see “Spin Reorientation of Magnetic Body and Application” by Kunitaro Tsushima, Applied Physics Vol. 45, No. 10 (1976), 962). Further, “thermomagnetic drive device” is disclosed in Japanese Patent Gazette No. 54-145908, “thermomagnetic drive device and thermal lead switch” is disclosed in Japanese Patent Gazette No. 6-5174, and “thermomagnetic driving method and actuator” is disclosed in Japanese Patent Gazette No. 7-4348. The first one is the motor capable of directly converting thermal energy into mechanical action by applying an external magnetic field and varying spin orientation with heat of rare-earth ortho ferrite. The second one is the device actuated by variation of magnetic permeability of a heat-sensitive magnetic material around Curie temperature (Tc). The third one is the motor and the actuator including a FeRh heat-sensitive magnetic film and a TbFe heat-sensitive magnetic film. The fourth one uses NiFe alloys, NiFeCr alloys or MnZn ferrite alloys as a heat-sensitive magnetic material using Curie temperature (Tc) and further uses FeRh alloys as a heat-sensitive magnetic material using magnetic primary phase transition temperature.

However, in the “photothermal motor”, “thermomagnetic drive device”, “themomagnetic drive device and thermal lead switch” and “thermomagnetic driving method and actuator”, only general ferrite alloys and NiFe alloys (inver alloys), general NiFeCr alloys (Elinvar alloys), FeRh alloys and TbFe alloys are disclosed. The ferrite materials are weak oxide ceramics, so it is difficult to process the ceramics. Since the Curie temperature of NiFe alloys are 100° C. or more, they cannot use at or lower than the Curie temperature. Curie temperature (Tc) of NiFeCr alloys can be controlled by adding rare metals. Rh of a precious metal and alloys including rare-earth metals are expensive materials. Many magnetic materials, which are made of intermetallic compounds including ferromagnetic members and whose Curie temperature is at or lower than 200° C., are known, but their Curie temperature (Tc) are uniquely determined, so their Curie temperature (Tc) cannot be continuously controlled by changing composition ratio. No means for efficiently absorbing photo energy, which constitutes a light receiving face of the heat-sensitive magnetic material, is disclosed. Further, the heat-sensitive magnetic material does not have a flat structure, which is capable of effectively minimizing the material.

The present invention is to solve the above described problems, and an object of the present invention is to provide a photothermal magnetic drive device driving method, a photothermal magnetic drive device and a production method for Ni based alloy with low-temperature Curie temperature using this, in each of which a Ni based ally (excluding NiFe alloys and NiFeCr alloys) capable of controlling a Curie temperature (Tc) by means of a composition ratio at comparatively low costs and consisting of an easy-workable low-temperature Curie-temperature (Tc) material.

### DISCLOSURE OF THE INVENTION

The method of the driving a photothermal magnetic drive device, which comprises: a support of a non-magnetic material supported rotatably; a plurality of heat-sensitive magnetic materials disposed on the support at intervals in the rotational direction thereof and each consisting of a Ni based alloy (excluding NiFe alloys and NiFeCr alloys) having low-temperature Curie temperature; a magnet disposed facing one of or a plurality of the heat-sensitive magnetic materials, for producing a magnetic field; and a heat collecting unit for spot-controlling heat from a photothermal source to a position deviated from the magnetizing center, by the magnet, on the heat-sensitive magnetic material facing the magnet, comprises the steps of: providing the photothermal drive device in a low temperature atmosphere, whose temperature is lower than the Curie temperature of the heat-sensitive magnetic materials; and collecting heat from the photothermal source by the heat collecting unit and supplying the heat to the position deviated from the magnetizing center on the heat-sensitive magnetic material so as to rise temperature of the position, whereby magnetization intensity of the position is lowered, and magnetic balance of the heat-sensitive magnetic material is affected so as to draw the heat-sensitive magnetic material in the rotational direction of the support to rotate the support.

And, the photothermal magnetic drive device comprises: a support of a non-magnetic material supported rotatably; a plurality of heat-sensitive magnetic materials disposed on the support at intervals in the rotational direction thereof and each consisting of a Ni based alloy (excluding NiFe alloys and NiFeCr alloys) having low-temperature Curie temperature; a magnet disposed facing one of or a plurality of the heat-sensitive magnetic materials, for producing a magnetic field; and a heat collecting unit for spot-controlling heat from a photothermal source to a position deviated from the magnetizing center, by the magnet, on the heat-sensitive magnetic material facing the magnet.

The photothermal magnetic drive device may further comprise a photothermal source, e.g., a laser device, an infrared ray device.

Preferably, the Ni based alloy is selected from Ni—Al alloys, Ni—Al—Si alloys, Ni—Ti alloys, Ni—Cr alloys, Ni—Mo alloys and Fe—Ni—Al alloys.

Preferably, the Ni based alloy is selected from Ni—Al alloys excluding Ni₃Al phases.

Preferably, surfaces of the heat-sensitive magnetic materials consisting of the Ni based alloy are coated with a black material.

The heat collecting unit may be a light collecting unit including a condensing lens, optical fibers, etc.

The support may be a circular rotary disk, and the heat-sensitive magnetic materials may be provided on one side face of the circular rotary disk and arranged, at fixed intervals, along a circle coaxial to an axis of the circular rotary disk.

In that case, the magnet may face an outer face and/or an inner face of the heat-sensitive magnetic material.

In another case, the magnet may be provided in a plane parallel to the heat-sensitive magnetic materials arranged along the coaxial circle so as to face the heat-sensitive magnetic materials.

The heat-sensitive magnetic materials may be fixed to ventilation fins, which are radially provided on one side face of the circular rotary disk, so that the drive device can be applied to a fan capable of ventilation and cooling the heat-sensitive magnetic materials.

The support may be a rotary drum, the heat-sensitive magnetic materials may be arranged, in a circumferential direction, on an outer face of the rotary drum at fixed intervals, and the magnet may be provided in the rotary drum.

Preferably, in that case, a plurality of rows of the heat-sensitive magnetic materials are arranged on the outer face of the rotary drum, and phases of the heat-sensitive magnetic materials of the adjacent rows are shifted in the circumferential direction of the rotary drum.

And, the heat-sensitive magnetic materials may be diagonally arranged with respect to an axis of the rotary drum.

The support may be formed into a trancated cone, the heat-sensitive magnetic materials may be arranged, in a circumferential direction, on an outer face of the trancated cone at fixed intervals, and the magnet may be provided in the trancated cone.

The production method of the present invention for a heat-sensitive magnetic material constituting of a Ni based alloy (excluding NiFe alloys and NiFeCr alloys) having low-temperature Curie temperature, comprising the steps of: forming alloy powders by mechanical-alloying Ni powders with metal powders; accommodating the alloy powders in a molding die; and pressurizing and heating the molding die by inputting pulse-electricity so as to sinter the alloy powders.

Further, the production method of the present invention for a heat-sensitive magnetic material constituting of a Ni based alloy (excluding NiFe alloys and NiFeCr alloys) having low-temperature Curie temperature, comprising the steps of: forming alloy powders by mechanical-alloying Ni powders with metal powders; melting the alloy powders in a vacuum furnace so as to form an alloy; and hardening the alloy.

The lead switch of the present invention comprises: an elastic conductive piece, which has electric conductivity and whose one end is fixed; a heat-sensitive magnetic material fixed to the other end of the elastic conductive piece, the heat-sensitive magnetic material constituting of a Ni based alloy (excluding NiFe alloys and NiFeCr alloys) having low-temperature Curie temperature; a magnet disposed facing the heat-sensitive magnetic material, the magnet producing a magnetic field; and lead wires respectively connected to the elastic conductive piece and the magnet.

Further, the lead switch of the present invention comprises: an elastic conductive piece, which has electric conductivity and whose one end is fixed; a magnet fixed to the other end of the elastic conductive piece, the magnet producing a magnetic field; a heat-sensitive magnetic material disposed facing the magnet, the heat-sensitive magnetic material constituting of a Ni based alloy (excluding NiFe alloys and NiFeCr alloys) having low-temperature Curie temperature; and lead wires respectively connected to the elastic conductive piece and the magnet.

### BRIEF DESCRIPTION OF THE DRAWINGS

FIG. 1 is a flow chart of a first production method for heat-sensitive magnetic materials;

FIG. 2 is a flow chart of a second production method for heat-sensitive magnetic materials;

FIG. 3 is graphs showing saturated magnetization-temperature characteristics of several composition ratios in a magnetic field of 10 kOe;

FIG. 4 is graphs showing saturated magnetization-temperature characteristics of several composition ratios in a magnetic field of 1 kOe;

FIG. 5 is graphs showing saturated magnetization-temperature characteristics of several composition ratios in a magnetic field of 10 kOe;

FIG. 6 is graphs showing saturated magnetization-temperature characteristics of several composition ratios in a magnetic field of 1 kOe;

FIG. 7 is graphs showing saturated magnetization-temperature characteristics of several composition ratios in a magnetic field of 10 kOe;

FIG. 8 is graphs showing saturated magnetization-temperature characteristics of several composition ratios in a magnetic field of 1 kOe;

FIG. 9 is a perspective view of a photothermal magnetic drive device of a first embodiment;

FIG. 10 is a plan view of the device of the first embodiment, in which an optical system is omitted;

FIG. 11 is a theoretical view explaining rotation of the device of the first embodiment;

FIG. 12 is a theoretical view of the first embodiment, in which a magnet angle is changed;

FIG. 13 is an explanation view of an examination system of the photothermal magnetic drive device;

FIG. 14 is a sectional view of a photothermal magnetic drive device of a second embodiment;

FIG. 15 is a plan view of the device of the second embodiment, in which an optical system is omitted;

FIG. 16 is a sectional view of a photothermal magnetic drive device of a third embodiment;

FIG. 17 is a plan view of the device of the third embodiment, in which an optical system is omitted;

FIG. 18 is a sectional view of a photothermal magnetic drive device of a fourth embodiment;

FIG. 19 is a plan view of the device of the fourth embodiment, in which an optical system is omitted;

FIG. 20 is a plan view showing an arrangement of magnets of the fourth embodiment;

FIG. 21 is a perspective view of a photothermal magnetic drive device of a fifth embodiment;

FIG. 22 is a sectional view of the photothermal magnetic drive device of the fifth embodiment;

FIG. 23 is a plan view of the device of the fifth embodiment, in which an optical system is omitted;

FIG. 24 is a perspective view of a photothermal magnetic drive device of a sixth embodiment;

FIG. 25 is a sectional view of the photothermal magnetic drive device of the sixth embodiment;

FIG. 26 is a theoretical view of the photothermal magnetic drive device of the sixth embodiment;

FIG. 27 is another theoretical view of the photothermal magnetic drive device of the sixth embodiment;

FIG. 28 is a perspective view of a photothermal magnetic drive device of a seventh embodiment;

FIG. 29 is a sectional view of the photothermal magnetic drive device of the seventh embodiment;

FIG. 30 is a theoretical view of the photothermal magnetic drive device of the seventh embodiment;

FIG. 31 is another theoretical view of the photothermal magnetic drive device of the seventh embodiment;

FIG. 32 is a perspective view of a photothermal magnetic drive device of a eighth embodiment;

FIG. 33 is a sectional view of the photothermal magnetic drive device of the eighth embodiment;

FIG. 34 is a theoretical view of the photothermal magnetic drive device of the eighth embodiment;

FIG. 35 is another theoretical view of the photothermal magnetic drive device of the eighth embodiment;

FIG. 36 is a perspective view of a photothermal magnetic drive device of a ninth embodiment;

FIG. 37 is a sectional view of the photothermal magnetic drive device of the ninth embodiment;

FIG. 38 is a theoretical view of the photothermal magnetic drive device of the ninth embodiment;

FIG. 39 is another theoretical view of the photothermal magnetic drive device of the ninth embodiment;

FIG. 40 is a perspective view of a photothermal magnetic drive device of a tenth embodiment;

FIG. 41 is a sectional view of the photothermal magnetic drive device of the tenth embodiment;

FIG. 42 is a theoretical view of the photothermal magnetic drive device of the tenth embodiment;

FIG. 43 is another theoretical view of the photothermal magnetic drive device of the tenth embodiment; and

FIG. 44 is an explanation view of a lead switch.

### BEST MODE OF THE EMBODIMENTS

Preferred embodiments of the present invention will now be described in detail with reference to the accompanying drawings.

Firstly, a production method for heat-sensitive magnetic materials used for a photothermal magnetic drive device and a method of driving the device will be explained.

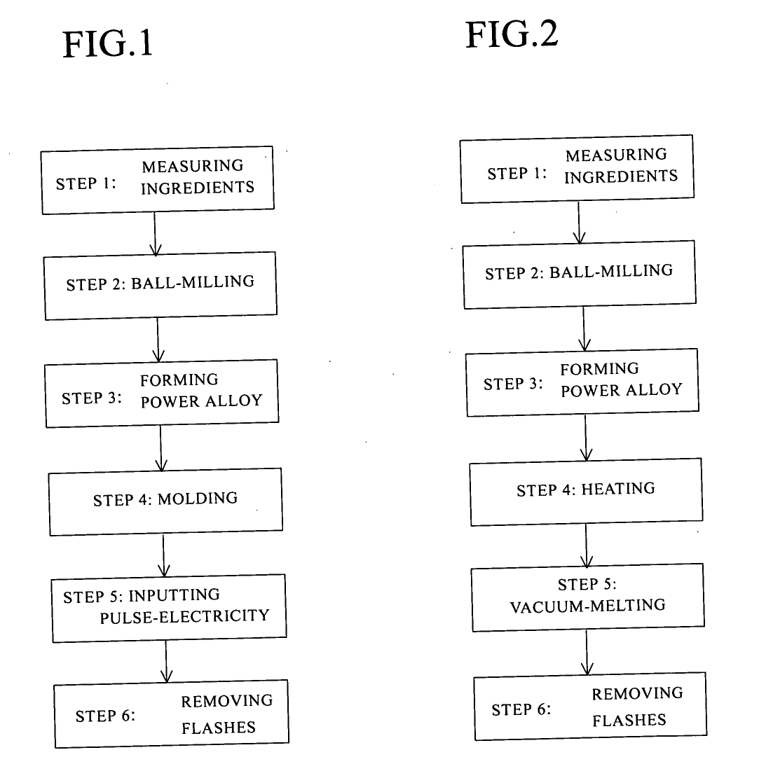

FIG. 1 is a flow chart of a first production method for the heat-sensitive magnetic materials.

Firstly, amount of ingredients are measured (STEP 1). The measured ingredients and milling balls are thrown into a planet type ball mill (STEP 2). The ingredients are ball-milled under prescribed conditions so as to form powder alloy (STEP 3). The powder alloy is put through a sieve, amount of the separated powder alloy is measured, and a molding die, which is made of graphite, is filled with the powder alloy (STEP 4). The powder alloy is sintered, under prescribed conditions, in a pulse-electric (discharge plasma) sintering unit so as to form a solidified body (STEP 5). Flashes or fins formed on the solidified body are removed, the solidified body is formed into a predetermined shape and polished so as to complete the heat-sensitive magnetic material (STEP 6).

A concrete example of a Ni—Al alloy produced by the first production method will be explained.

### EXAMPLE 1

| | | | | |
|---|---|---|---|---|
| STEP 1: | Ingredient powders | Ni | 28.542 | g |
| | | Al | 1.458 | g |
| | Lubricant | stearic acid | 0.3 | g |

STEP 2: The ingredients and the lubricant were thrown into the planet type ball mill, whose capacity was 500 ml, with 100 milling balls, whose diameter was 10 mm and which were made of stainless steel.

STEP 3: The ingredients and the lubricant were ball-milled for 20 hours with rotational speed of 200 rpm in an Ar gas atmosphere, in which gas pressure was 74.6 kPa, so as to form the powder alloy (mechanical ironing).

STEP 4: The powder alloy was put through the sieve, 30 g of the separated powder alloy, whose size was 53 i m or less, was supplied into the graphite die, whose diameter was 20 mm.

STEP 5: The powder alloy was sintered for 5 minutes at 900° C. with pressure of 29.4 MPa in the pulse-electric sintering unit. Note that, a total treatment time was 22 minutes.

STEP 6: Flashes or fins formed on the solidified body were removed, the solidified body was formed into a predetermined shape having a prescribed size, and it was polished by sandpaper, so that the heat-sensitive magnetic material Ni0.9A10. 1 (10 at % Al—Ni alloy) was completed.

FIG. 2 is a flow chart of a second production method for the heat-sensitive magnetic materials.

STEPS 1-3 are equal to those of the first method, so the powder alloy is formed by the mechanical ironing. In the second method, the power alloy is once collected and thrown into a melting pot (STEP 4). Then, the powder alloy is melted in a vacuum furnace, and the melted alloy is rapidly cooled (hardened) by an argon gas (an inert gas), so that a solidified body can be formed (STEP 5). Flashes or fins formed on the solidified body are removed, the solidified body is formed into a predetermined shape and polished so as to complete the heat-sensitive magnetic material (STEP 6).

A concrete example of a Ni—Al alloy produced by the second production method will be explained.

### EXAMPLE 2

| | | | | |
|---|---|---|---|---|
| STEP 1: | Ingredient powders | Ni | 28.542 | g |
| | | Al | 1.458 | g |
| | Lubricant | stearic acid | 0.3 | g |

STEP 2: The ingredients and the lubricant were thrown into the planet type ball mill, whose capacity was 500 ml, with 100 milling balls, whose diameter was 10 mm and which were made of stainless steel.

STEP 3: The ingredients and the lubricant were ball-milled for 20 hours with rotational speed of 200 rpm in an Ar gas atmosphere, in which gas pressure was 74.6 kPa, so as to form the powder alloy (mechanical ironing).

STEP 4: The powder alloy was collected and thrown into the melting pot.

STEP 5: The powder alloy was heated for 1 hour at 1480° C. with pressure of 133 Pa (argon gas) in the vacuum furnace so as to melt the powder alloy, then the argon gas was purged, the melted alloy was rapidly cooled to form a solidified body.

STEP 6: Flashes or fins formed on the solidified body were removed, the solidified body was formed into a predetermined shape having a prescribed size, and it was polished by sandpaper, so that the heat-sensitive magnetic material Ni0.9A10.1 (10 at % Al—Ni alloy) was completed. Note that, the production conditions are not limited to those of the examples.

According to results of X-ray diffraction tests, no Ni₃Al was formed in the heat-sensitive magnetic materials of the examples.

Curie temperature of Ni₃Al is a very low temperature, i.e., —198° C.; if Ni₃Al is extracted in the alloy, magnetic characteristics of the heat-sensitive magnetic materials in an operating temperature range —10° C.—150° C. (preferably, around room temperature: 10° C.-30° C.) will be worse.

A composition ratio of metallic components of the heat-sensitive magnetic material is determined by that of the metallic ingredients.

We produced the heat-sensitive magnetic materials, which have following composition ratios, with the first and the second methods.

\mathring{1} Ni0.91A10.09 (9 at % Al—Ni alloy);

\mathring{2} Ni0.9A10.1 (10 at % Al—Ni alloy);

\mathring{3} Ni0.89A10.11 (11 at % Al—Ni alloy);

\mathring{4} Ni0.87A10.13 (13 at % Al—Ni alloy);

\mathring{5} Ni0.86A10.14 (14 at % Al—Ni alloy);

\mathring{6} Ni0.85A10.15 (15 at % Al—Ni alloy); and

\mathring{7} Ni0.84A10.16 (16at % Al—Ni alloy).

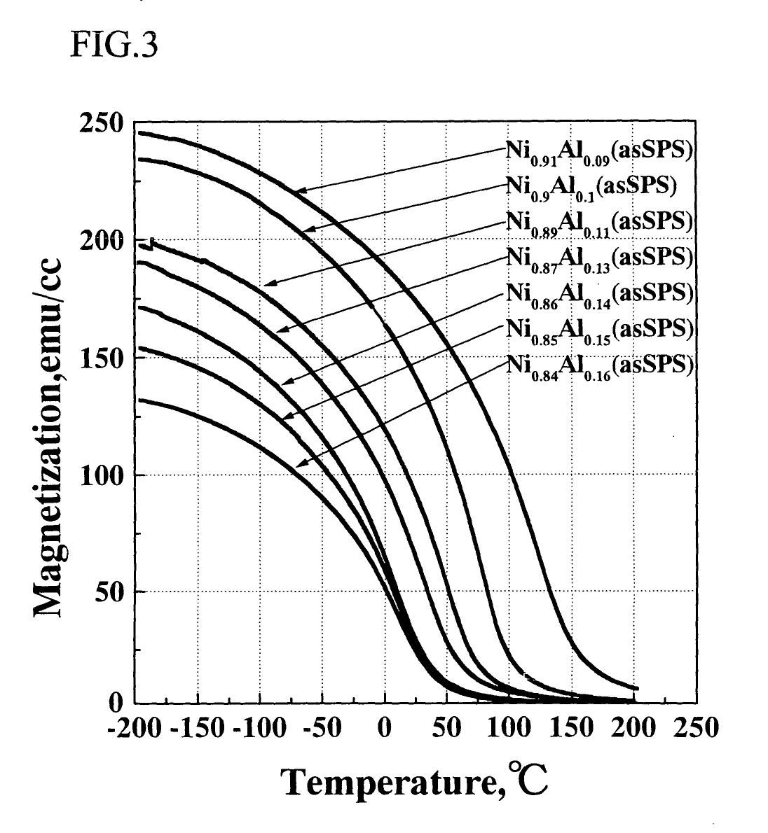

FIG. 3 is graphs showing saturated magnetization-temperature characteristics of the composition ratios in a magnetic field of 10 kOe. In the graphs, a symbol “asSPS” means the material which has been sintered by discharge plasma.

The Curie temperature is lowered with increasing the amount of Al; the Curie temperature of the materials, whose amount thereof is greater than that of Ni0.86A10.14(14 at % Al—Ni alloy), is fixed. In the case of using at room temperature, the preferable materials are Ni0.9A10.1 (10 at % Al—Ni alloy)-Ni0.87A10.13 (13 at % Al—Ni alloy).

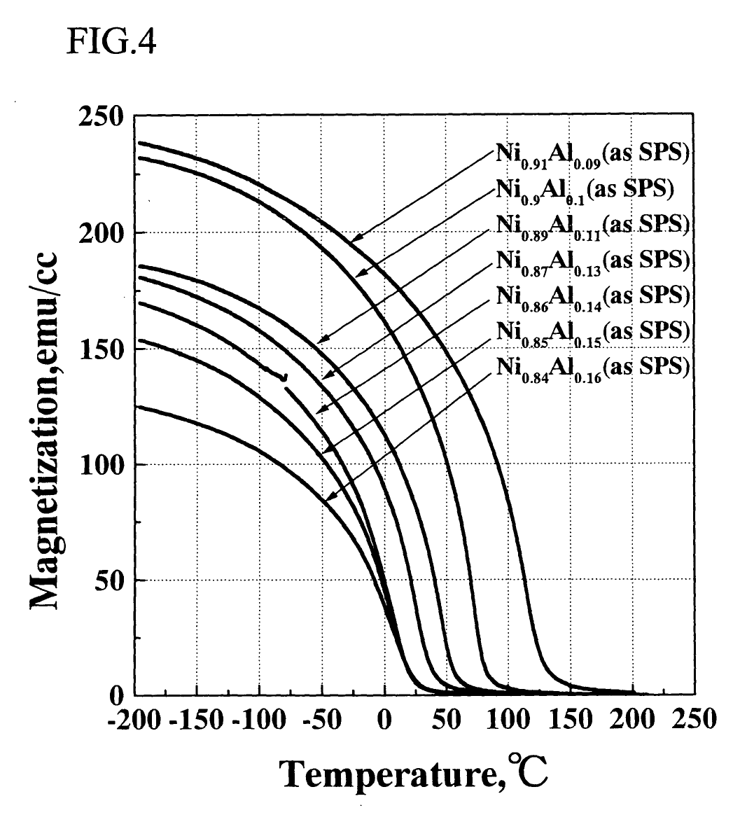

FIG. 4 is graphs showing saturated magnetization-temperature characteristics of the composition ratios in a magnetic field of 1 kOe. Inclination of the graphs are steeper than that in the graphs of the strong magnetic field of 10 kOe, so the materials can be preferably used as the heat-sensitive magnetic materials.

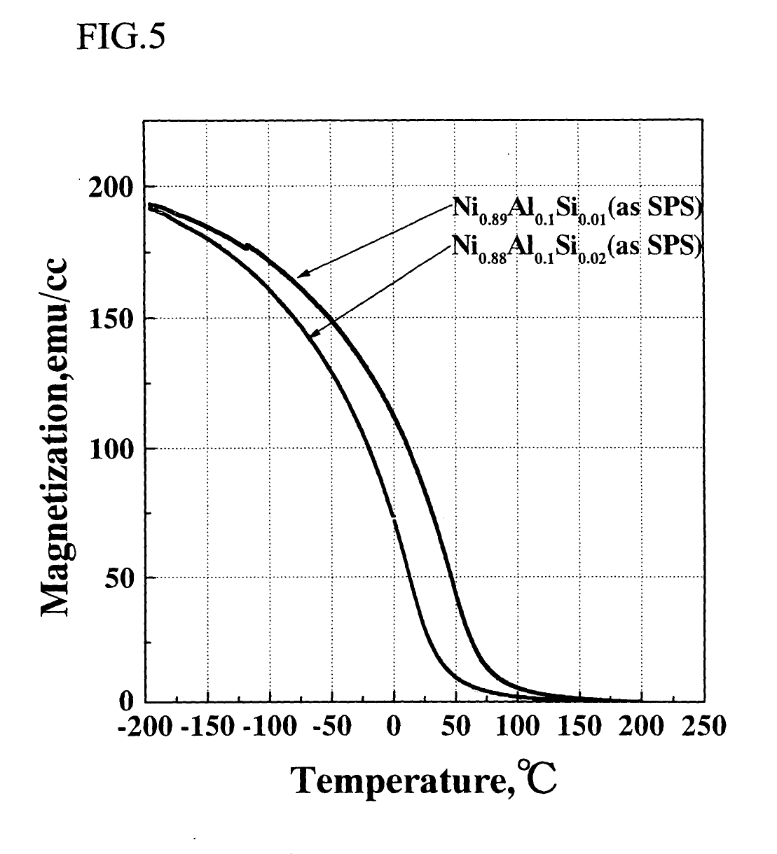

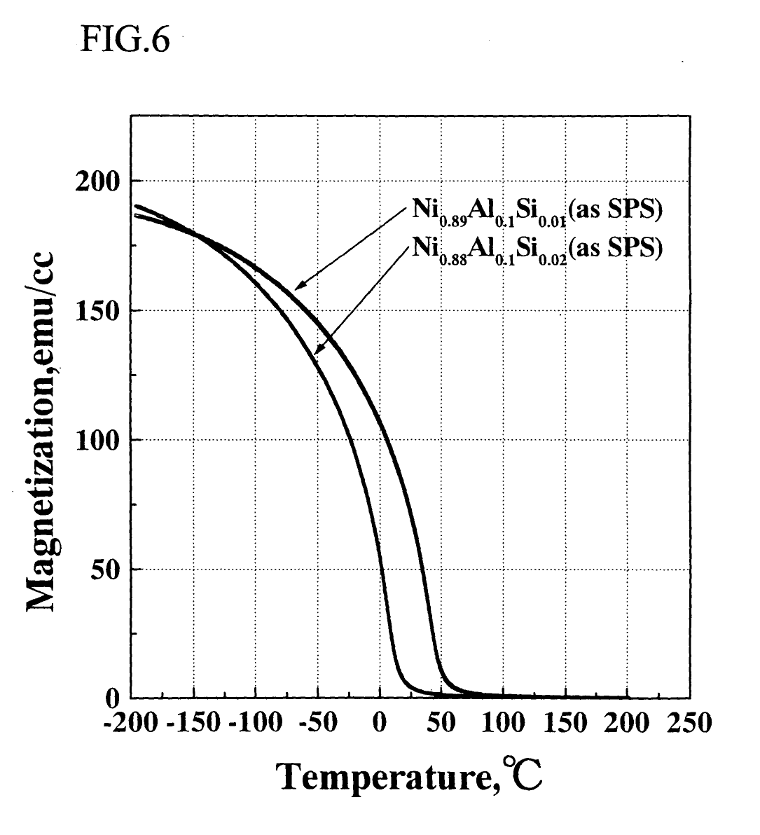

FIG. 5 is graphs showing saturated magnetization-temperature characteristics of materials, each of which is a Ni—Al alloy to which Si is further added, in a magnetic field of 10 kOe; FIG. 6 is graphs showing saturated magnetization-temperature characteristics thereof in a magnetic field of 1 kOe. The Ni—Al—Si alloys can be produced by said first and second methods.

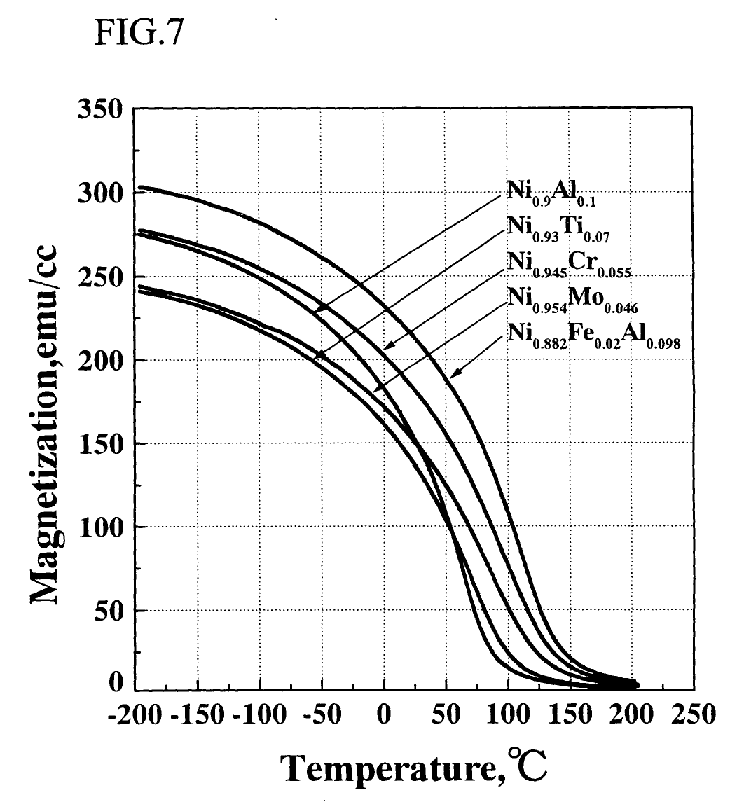

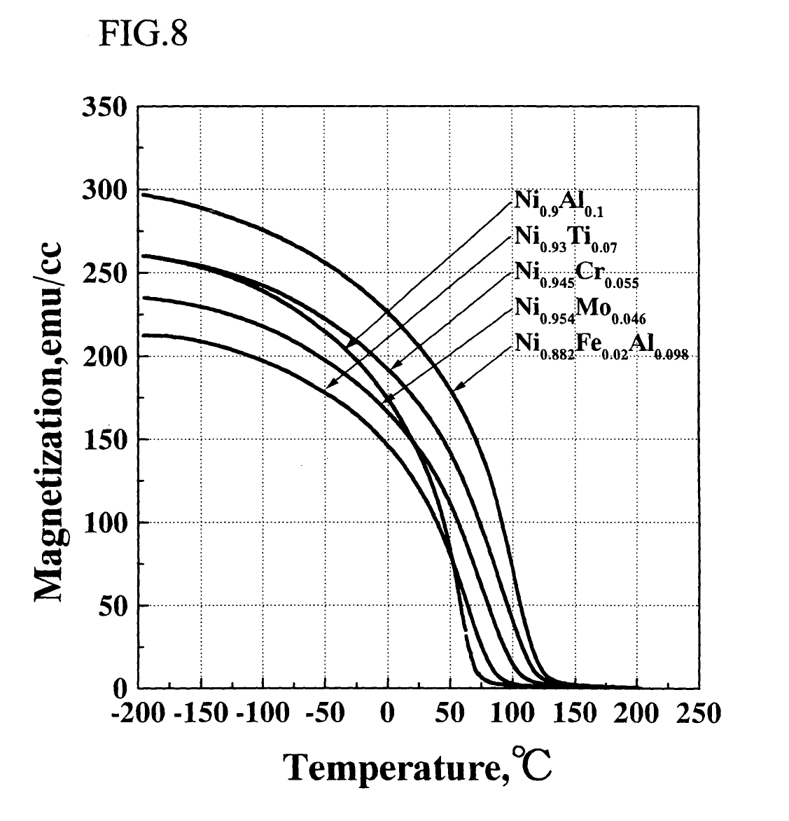

FIG. 7 is graphs showing saturated magnetization-temperature characteristics of materials, which are alloys to which Ti, Cr and Mo are respectively added instead of Al and a Ni—Al alloy to which Fe is further added, in a magnetic field of 10 kOe; FIG. 8 is graphs showing saturated magnetization-temperature characteristics thereof in a magnetic field of 1 kOe. The alloys also can be produced by said first and second methods. Composition ratios of the alloys may be varied ±5 % with respect to the shown composition ratios of the metallic components so as to use as object heat-sensitive magnetic materials.

According to the graphs, the variation of the magnetic characteristics of Ni—Al alloys is superior to others.

Note that, in the present invention, Ni based alloys with low-temperature Curie temperature means Ni based alloys whose Curie temperatures are at or lower than 200° C. and whose saturated magnetization-temperature characteristics graphs are most inclined within a temperature range of −10° C.-150° C.

Successively, embodiments of the photothermal magnetic drive device using the photothermal magnetic materials and their driving method will be explained.

[First Embodiment]

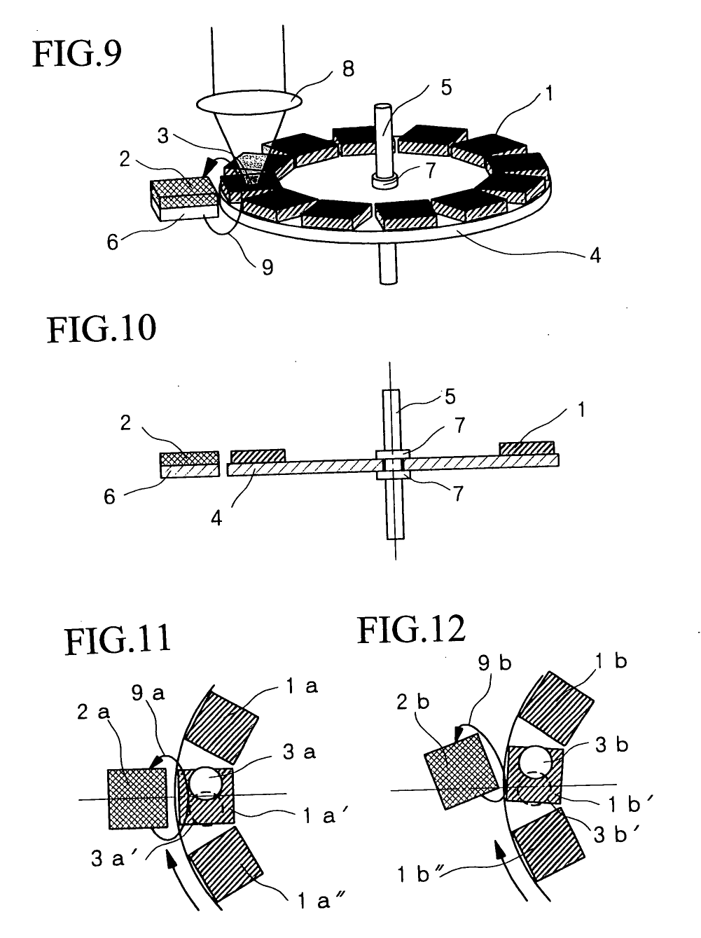

A basic structure of a motor using the heat-sensitive magnetic materials, which is an example of the photothermal magnetic drive device, is shown in FIGS. 9 and 10. FIG. 9 is a perspective view of the motor; FIG. 10 is a sectional view thereof.

A plurality of heat-sensitive magnetic chips 1, which are made of the Al—Ni alloy, are disposed and fixed on one side face of a support (a circular disk-shaped support) 4, which is made of a non-magnetic material having low heat conductivity, e.g., ceramic, at intervals in the rotational direction of the support 4. To effectively absorb photothermal energy, light receiving surfaces of the chips 1 may be coated with black material. Heat-resisting resin including black carbon may be used as the black material to coat the chips, and black materials may be stuck on the chips by sputtering. Further, Ni based black oxide films can be formed on the chips by oxidizing the chips in an atmosphere, in which oxygen density is lowered.

The support 4 is a rotatable disk, and a rotary shaft 5 and a bearing 7 are provided at the center thereof. A permanent magnet 2 shown in FIG. 9 has one magnetic pole, and it is fixed on a plate (supporting plate) 6, whch is made of a non-magnetic material, e.g., aluminum alloys, magnesium alloys. To vary magnetic characteristics of the chips 1 with rising temperature, a heat (light) collecting unit including a lens 8 directly or indirectly irradiates lights (heat), which are supplied from a photothermal source, e.g., laser beams (from a laser unit), sunlight, infrared rays (from an infrared ray unit), to the surface of each chip 1 (to a position deviated from the magnetizing center by the magnet 2), which is made of the heat-sensitive magnetic material, via lenses or optical fibers.

A theory of rotating the support will be explained with reference to FIG. 11.

Atmosphere temperature is around room temperature lower than Curie temperature. Before lights, e.g., laser beams, are irradiated, the heat-sensitive magnetic material, which has soft magnetism and located close to the permanent magnet 2, is magnetized by a magnetic field 9 of the permanent magnet, and the support is balanced as shown in FIG. 9.

When the laser beam is irradiated to a circular spot 3a (the position deviated from the magnetizing center by the magnet 2a) of the chip 1a′, the spot of the chip 1a′ is heated, so that magnetization intensity of the spot is lowered. Note that, in some cases, a laser power rises the temperature of the spot 3a of the chip 1a′ until Curie temperature.

In any cases, magnetic balance in the chip 1a′ is affected by spot-heating; other parts of the chip 1a′, whose temperature are lower than that of the heated spot, are drawn by the magnetic field 9a of the permanent magnet 2a, so that the support begins to rotate in a direction of an arrow. The whole chip 1a′ is rapidly heated, and the adjacent chip 1a″ is drawn by the magnetic field of the permanent magnet 2a, so that rotational speed of the support is accelerated. The laser beams may be continuously irradiated or irradiated like pulses so as to gain rotational moment. If the case of continuously irradiating laser beams, the chip 1a″ is heated as well, and the magnetic balance therein is affected. By repeating the affection of the magnetic balance in the chips, the support can be continuously rotated. Since volume of each chip is small, the chip 1a′ can be fully natural-cooled until reaching the initial position so that the magnetic characteristics are improved. By repeating the heating and the cooling, the support can be continuously rotated.

In the case of using the Curie temperature of the heat-sensitive magnetic materials, the Curie temperature must be equal to or higher than atmosphere temperature. Preferably, in the case of Ni—Al alloys, a temperature cycle about 5-20° C. is required to generate stable rotational torque.

In the present theory, the support can be easily rotated in the reverse direction; the support is rotated in the counterclockwise direction by heating a spot 3a′ shown in FIG. 11.

Unlike the example shown in FIG. 9 in which the shape of the magnetic field is symmetry to the chip, the magnetic field 9b of the permanent magnet 2b shown 12 is asymmetrically arranged (diagonally arranged) thereto so as to improve sensitivity of the rotation; preferably, the permanent magnet 2b is diagonally arranged so as to make the corner of the magnet, which is located close to the support, approach to one side of the chip, which is opposite side of the spot 3b. With this structure, the chip 1b′, whose magnetic balance has been affected, can be strongly drawn, so that sensitivity (responsibility) of the rotation can be improved.

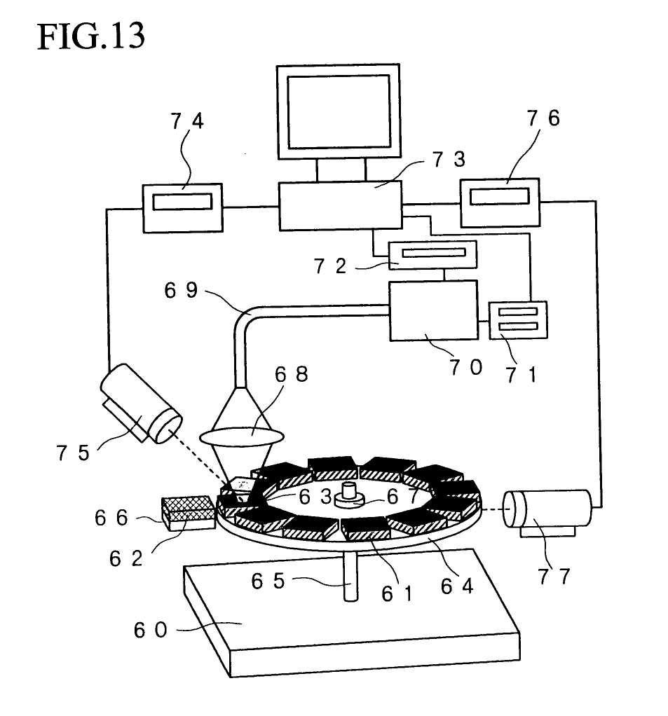

Experiments of the alloys with low-temperature Curie temperature were executed in a system shown in FIG. 13. Chips 61 made of a Ni—Al heat-sensitive magnetic material, whose size was 1 mm×1 mm and whose thickness was 0.5 mm, were fixed on a rotary disk (a support) 64, which was made of alumina ceramic and whose diameter was 20 mm, at regular intervals. Light receiving faces of the chips 61 were coated with a black material so as to improve heat absorptivity. Number of poles of the chips 61 may be optionally determined as far as the adjacent chips 61 do not contact each other. A rare-earth permanent magnet 62 was fixed to a non-magnetic aluminum alloy plate 66. The rotary disk 64 made of alumina ceramic could be freely rotated about a rotary shaft 65 and a bearing 67. A laser beam from a semiconductor laser unit 70 was introduced to a lens 68 via optical fibers 69 and focused to a spot 63. The position of the focus spot is shown in FIG. 11.

Oscillation of the semiconductor laser was controlled by a pulse generator 71, so continuous rotation of the rotary disk was caused by continuous oscillation; stepping rotation of the rotary disk was caused by pulse oscillation. Rotational speed or the rotary disk was controlled by a laser power controller 72. Surface temperature of the heat-sensitive materials were measured by radiation thermometers 74 and 75. The rotational speed of the rotary disk was measured by rotation measuring units 76 and 77. Data were processed by a personal computer 73. For example, 39 chips made of the alloy Ni0.9A10.1 (10 at % Al—Ni alloy) were arranged on the rotary disk, whose diameter was 20 mm, and electric power of 700 mW was applied, so that the rotary disk was rotated at rotational speed of 100 rpm.

Other embodiments of the photothermal magnetic drive device will be explained.

[Second Embodiment]

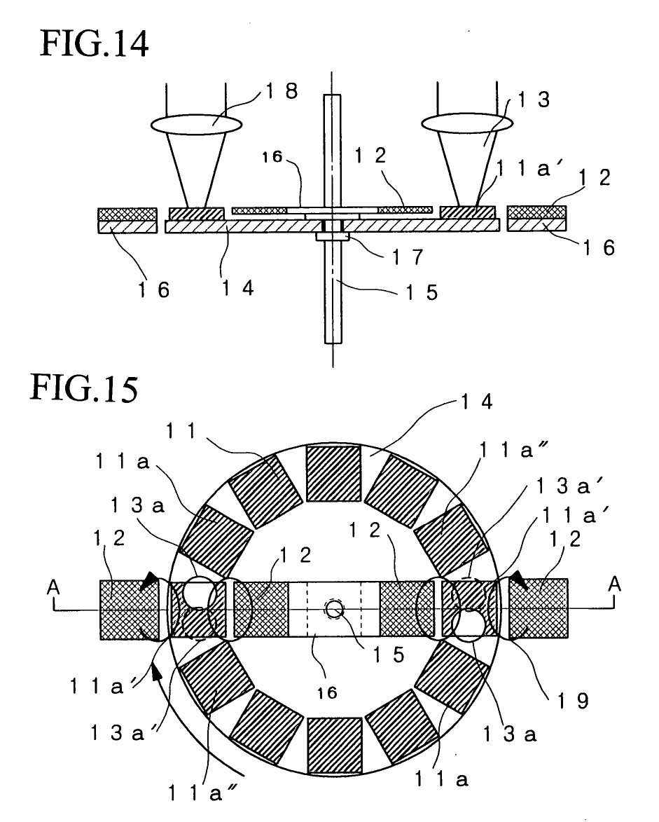

In the present embodiment shown in FIGS. 14 and 15, two couples of permanent magnets are used. FIG. 14 is a sectional view; FIG. 15 is a plan view.

Light receiving surfaces of chips 11 are coated with a black material as well as the chips shown in FIG. 9.

A plurality of the chips 11 are disposed and fixed on one side face of a support (a circular disk-shaped support) 14, which is made of a non-magnetic material having low heat conductivity, e.g., ceramic, at intervals in the rotational direction of the support 14. The support 14 is attached to a shaft 15 with a bearing 17, so that it is capable of freely rotating with respect to the shaft 15. The permanent magnets 12 are respectively fixed to holding plates 16, two magnetic poles are provided on the inner side of the chips, two magnetic poles are also provided on the outer side of the chips, laser beams are focused to two spots 13a by lenses 18. A symbol 19 stands for a magnetic field.

Only the outer magnets 12 generate torque greater than that generated by one-pole magnet, further greater torque can be gained by providing the inner magnets. The rotary disk can be rotated in the reverse direction as well as the embodiment shown in FIG. 9.

[Third Embodiment]

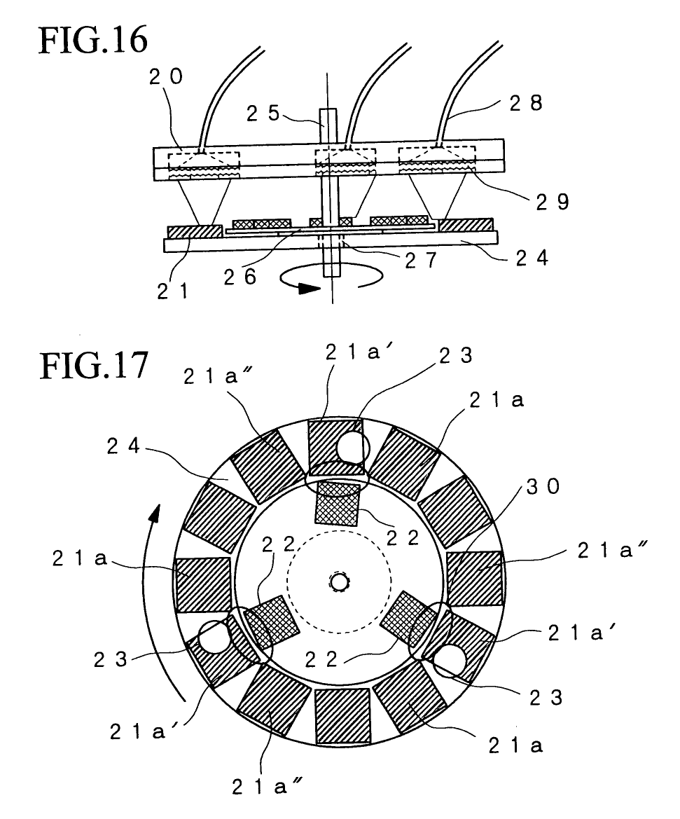

In the present embodiment shown in FIGS. 16 and 17, three permanent magnets are used. FIG. 16 is a sectional view; FIG. 17 is a plan view.

Chips 21 made of the heat-sensitive magnetic material are fixed on a rotary disk 24 made of a non-magnetic material. Surfaces of chips 21 are coated with a black material. The rotary disk 24 is attached to a shaft 25 and capable of freely rotating. The permanent magnets 22 are arranged on a non-magnetic circular disk 26, which is fixed to the shaft 25, with angular separations of 120 degrees, and they are provided on the inner side of the chips 21.

Next, a lens system will be explained. Three Fresnel condensing lenses 29 are arranged with angular separations of 120 degrees so as to irradiate lights to spots 23. The spots can be optionally changed in the circumferential direction by turning a plate to which the lenses 29 are fixed. In the case of irradiating laser beams, the laser beams are introduced into the lenses via optical fibers 28. The optical fibers are fixed to a disks 20. The spots 23 are the focus spots, and a symbol 30 stands for a magnetic field.

When the laser beams irradiate to the spots 23 in light receiving faces of the chips 21a′, which are coated with the black material, magnetization intensity of the spots 23 are lowered, so that the rotary disk 24 begins to rotate in the clockwise direction, then the chips 21a″ are irradiated, so that the rotary disk continuously rotates as well as the former embodiment.

In the case of using the sunlight widely irradiating; an axis of the device is arranged parallel with respect to the direction of the sunlight, so that the lenses 29 focus the sunlight to the spots in the chips 21 and a rotary action of the rotary disk can be gained.

[Fourth Embodiment]

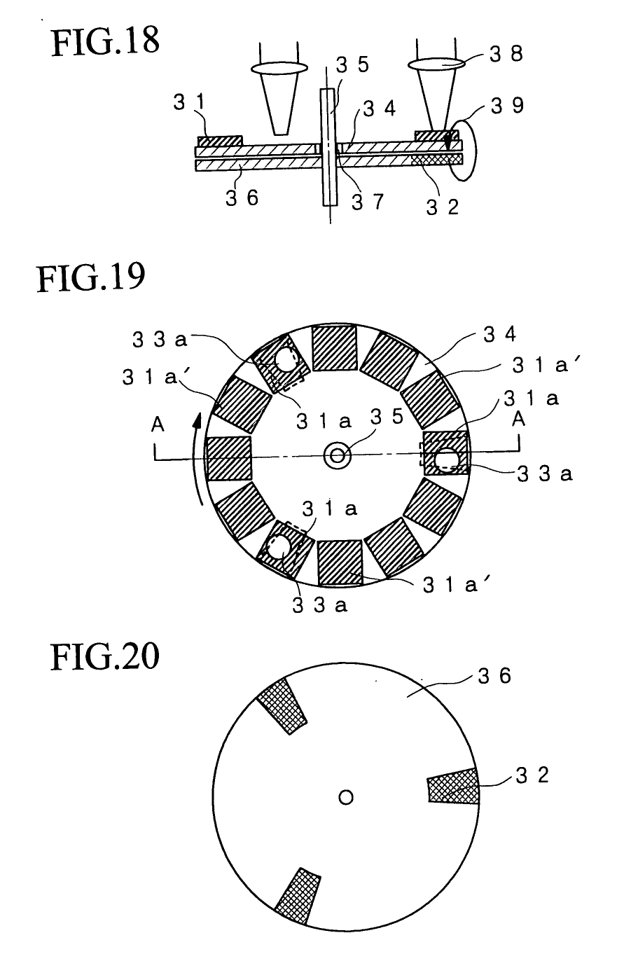

In the present embodiment shown in FIGS. 18-20, permanent magnets are arranged parallel to the heat-sensitive magnetic chips.

FIG. 18 is a sectional view (taken along a line A-A shown in FIG. 2); FIG. 19 is a plan view; FIG. 20 is a plan view of an arrangement of the permanent magnets.

The permanent magnets 32, which are magnetized in the vertical direction, are fixed on a non-magnetic disk 36 with separations of 120 degrees. The disk 36 is fixed to a shaft 35. A plurality of the heat-sensitive magnetic chips 31, whose light receiving faces are coated with a black material, are arranged and fixed on a rotary disk 34 made of a non-magnetic material having low heat conductivity, e.g., ceramic, at regular intervals. The rotary disk 34 is attached to the shaft 35 and capable of freely rotating. A symbol 39 stands for a magnetic field. When lights, e.g., laser beams, irradiate spots 33a in the chips 31a via condensing lenses 38 so as to affect magnetic balance of the chips 31a, the rotary disk begins to rotate in a direction of an arrow as well as the former embodiments. Then, the chips 31a′ are irradiated, so that the rotary disk can continuously rotate.

Since the permanent magnets 32 and the heat-sensitive magnetic chips 31 are formed as thin films and they are provided on the thin disks 36 and 34, the device can be applied to micro motors, micro actuators, etc..

[Fifth Embodiment]

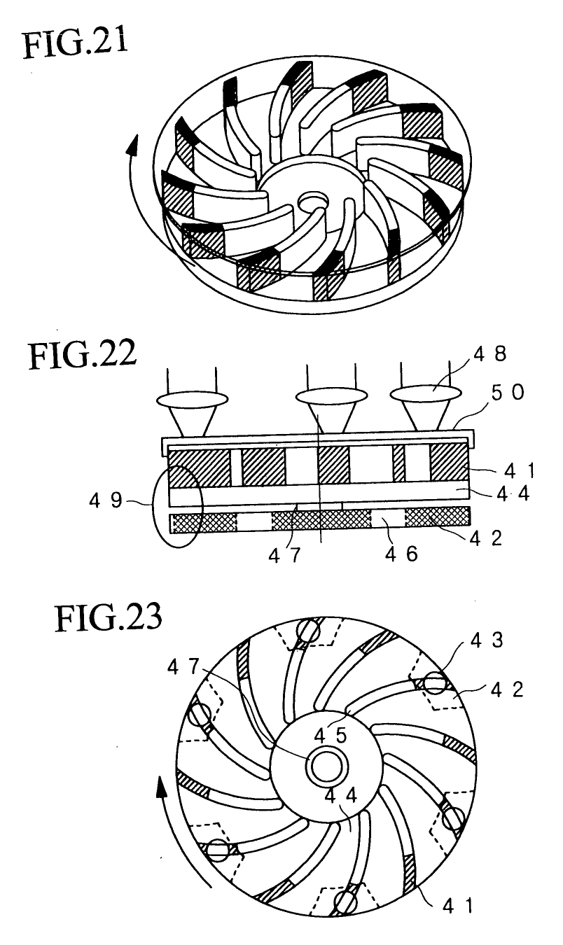

FIGS. 21-23 show a micro fan capable of ventilating air and cooling the heat-sensitive magnetic materials. resisting, permanent magnets are arranged parallel to the heat-sensitive magnetic chips. FIG. 21 is a perspective view; FIG. 22 is a sectional view; FIG. 23 is a plan view in which a lens system is omitted.

A support disk 44, which is made of a non-magnetic material having low heat conductivity, is freely rotatably attached on a circular disk 46, which is made of a non-magnetic material, by a bearing 47. A plurality of ventilation fins 40, which are made of a non-magnetic material, are radially arranged on the support disk 44. A heat-sensitive magnetic chip 41 is fixed to a front end of each fin 40. In the present embodiment, 12 fins 40 are arranged at regular intervals. Therefore, 12 poles or chips 41 are provided. Light receiving faces of the chips 41 are coated with a black material.

Permanent magnets 42 are arranged in the circular disk 46 with angular separations of 60 degrees.

When lights, e.g., laser beams, simultaneously irradiate spots 43 in the chips, which are separated with regular angular separations of 60 degrees, via lenses 48 of a light or heat collecting unit 50. Magnetization intensity of the irradiated parts of the chips 41 are lowered, so that the chips 41 of the fins 40 close to the permanent magnets 42 are drawn by the magnets and the fan can continuously rotate.

Note that, temperature of a fluid to be ventilated must be lower than Curie temperature of the heat-sensitive magnetic chips 41, preferably the difference is 10° C. or more so as to stably rotate the fan.

In the present embodiment, the heat-sensitive magnetic chips 41 are cooled by self-generated wind, so that the fan can continuously rotate with higher responsibility.

Heat generated in semiconductor chips may be collected, as the photothermal source, by heat pipes, and the spots 43 may be heated by the collected heat so as to continuously rotate the fan. Further, the fan can send air toward semiconductor devices, so that the fan can be used as a cooling fan.

[Sixth Embodiment]

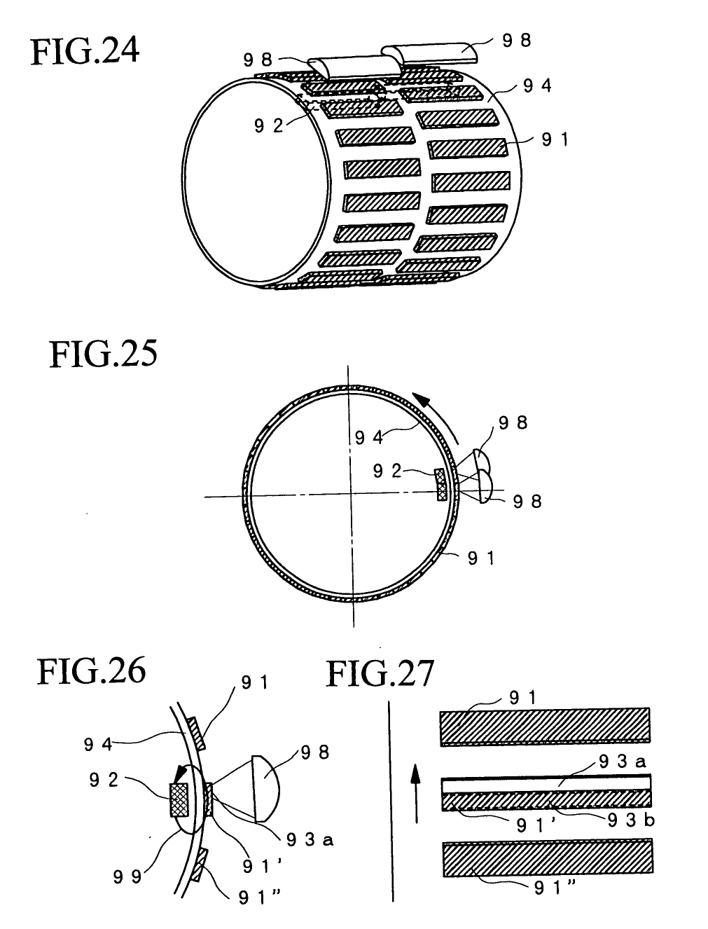

FIGS. 24-27 show the drive device of the sixth embodiment, which uses the sunlight and has a drum-shaped rotor. FIG. 24 is a perspective view of the device; FIG. 25 is a sectional view thereof; FIGS. 26 and 27 are theoretical views thereof.

A cylindrical rotary drum 94 is rotatably held by a proper shaft or member (not shown) and capable of rotating about the shaft or member.

To smoothly rotate the rotary drum, two rows of thin rectangular heat-sensitive magnetic materials 91 are circularly arranged on the rotary drum 94 at regular intervals, and phases of the heat-sensitive magnetic materials of the adjacent rows are shifted in the circumferential direction of the rotary drum.

Surfaces of the heat-sensitive magnetic materials 91 are coated with a black material.

The sunlight is collected by condensing lenses 98. Permanent magnets 92 for drawing the rotary drum are provided on the inner side of the rotary drum 94 and held by a proper holding member (not shown).

As shown in FIGS. 26 and 27, the sunlight is focused to spots 93a, each of which is slightly deviated from the magnetizing center of a magnetic field 99, so that rotational torque in a direction of an arrow can be gained as well as the former embodiments.

By shifting the phases of the heat-sensitive magnetic materials 91, a rotational force can be gained with fine pitches.

In the present embodiment, the sunlight is collected by the wide lenses 98, light collecting area can be made broader and the sunlight can be effectively used. Therefore, a great output power can be gained; the power can be used as a driving source of an electric generator (not shown). The electric generator may be installed in the rotary drum 94.

Further, the drive devices may be serially connected in the axial direction by universal joints so as to generate greater torque.

[Seventh Embodiment]

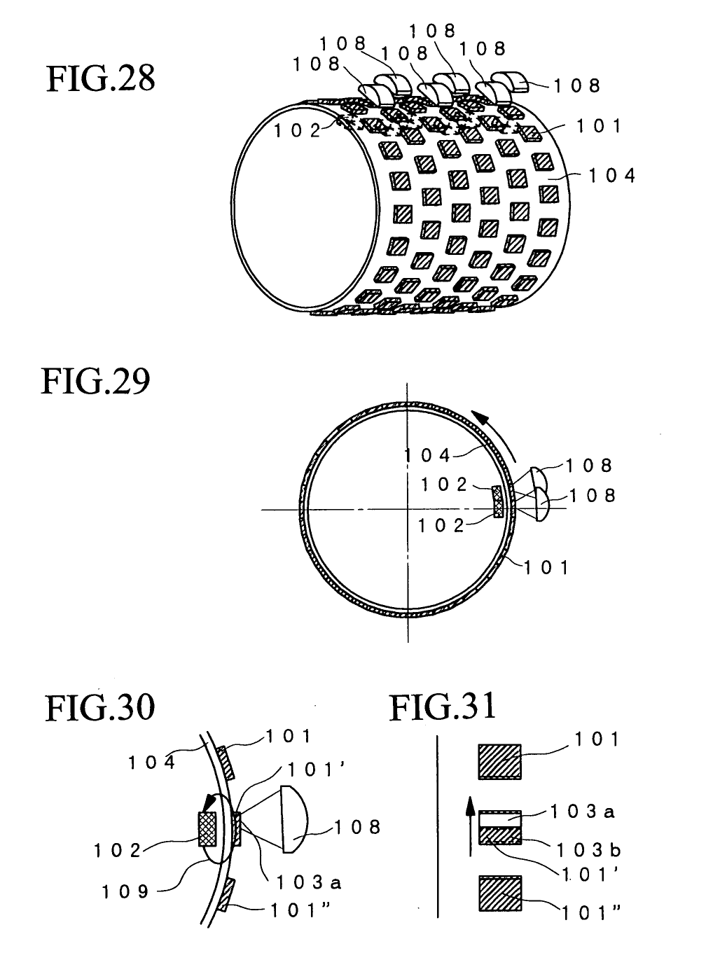

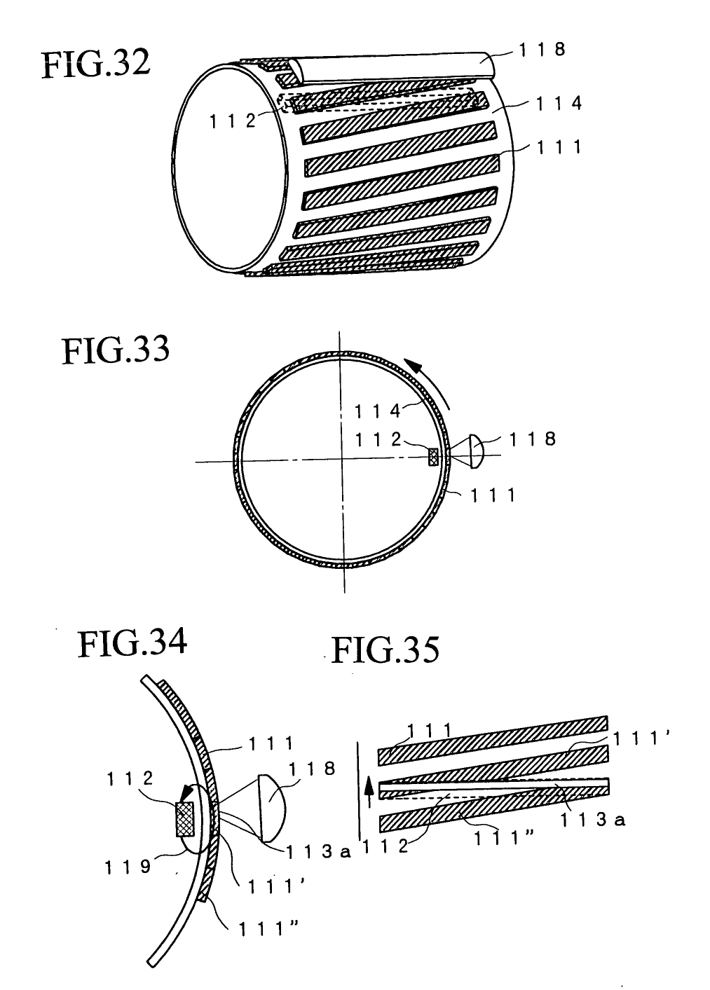

FIGS. 28-31 show the drive device having a plurality or rows of heat-sensitive magnetic chips 101, which are formed by cutting the rectangular heat-sensitive magnetic materials of the sixth embodiment, and other structures are equal to those of the sixth embodiment.

In the present embodiment, 6 rows of the chips 101 are arranged on an outer circumferential face of a rotary drum 104, and phases of the chips 101 of the adjacent rows are shifted in the circumferential direction of the rotary drum 104.

A symbol 102 stands for permanent magnets; a symbol 103a stands for a focus spot; a symbol 108 stands for a lens (condensing lens); a symbol 109 stands for a magnetic field.

In the present embodiment too, the rotary drum 104 can be rotated as well as the former embodiment. Further, the drive device can be used as a driving source of an electric generator as well as the former embodiment.

[Eighth Embodiment]

In the present embodiment, a rotary drum 114 is used, and thin rectangular heat-sensitive magnetic materials 111 are provided on an outer circumferential face of the drum 114 at regular intervals and diagonally arranged with respect to an axial line of the drum. Surfaces of the heat-sensitive magnetic materials 111 are coated with a black material.

A condensing lens (a half-columnar lens) 118 is thin and long and arranged parallel to the axial line of the drum 114. A thin and long permanent magnet 112 is provided in the drum 114 and arranged parallel to the axial line of the drum 114.

A symbol 113a stands for a focus spot, and a symbol 119 stands for a magnetic field.

In the present embodiment, the focus spot 113a always bridges over the adjacent heat-sensitive magnetic materials.

As shown in FIG. 35, when the light is focused to the focus spot 113a, magnetization intensity of the heat-sensitive magnetic material 111″ is lowered from a right end thereof, so the rotary drum 114 is rotated in a direction of an arrow. Since the focus spot 113a always bridges over the adjacent heat-sensitive magnetic materials, the rotary drum can be rotated smoothly.

[Ninth Embodiment]

In the present embodiment too, a rotary drum is used, and two rows of thin rectangular heat-sensitive magnetic materials 121 are provided on an outer circumferential face of the drum 124 at regular intervals and diagonally arranged with respect to an axial line of the drum. Surfaces of the heat-sensitive magnetic materials 121 are coated with a black material.

Each couple of the heat-sensitive magnetic materials 121 in the first row and the second row are arranged non-parallel and inclined oppositely.

Condensing lenses (half-columnar lenses) 128 are inclined to correspond to the rows of the heat-sensitive magnetic materials 121. arranged parallel to the axial line of the drum 124. Permanent magnets 122 are provided in the drum 124 and arranged parallel to the heat-sensitive magnetic materials.

A symbol 129 stands for a magnetic field, and a symbol 123a stands for a focus spot.

The rotary drum 124 of the present embodiment is rotated, as well as that of the former embodiment, in a direction of an arrow shown in FIG. 39.

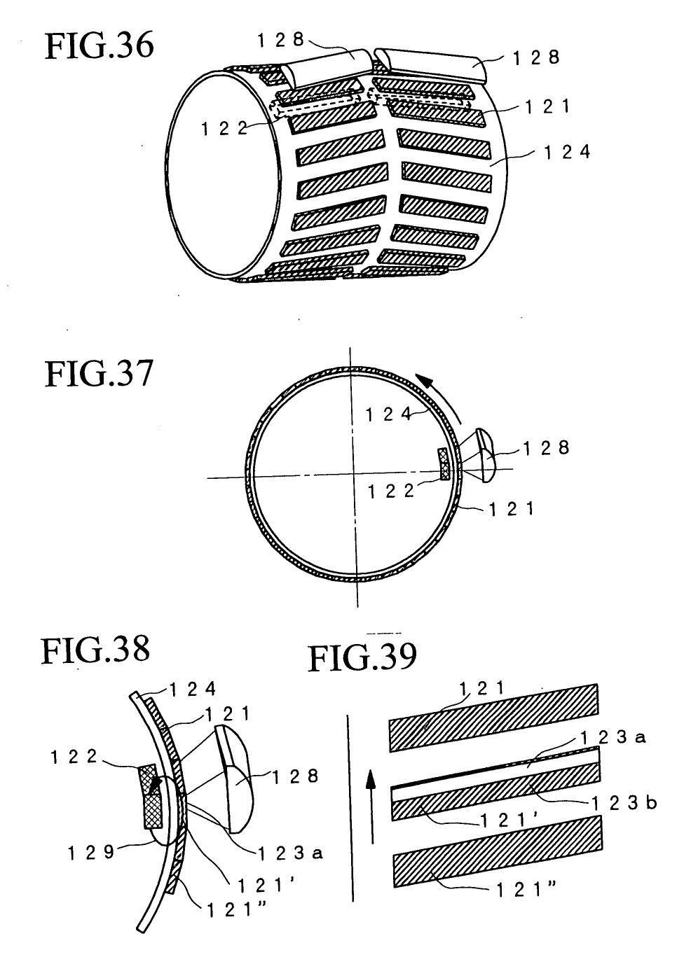

If the rotary drum 124 is arranged in the east-west direction, the sunlight is mainly focused by the condensing lenses 128 while the sun moves along the ecliptic from east to west. The sunlight is mainly focused by the lens 128 on the right side of FIG. 36 in the morning, the sunlight is mainly focused by the lens 128 on the left side in the afternoon, so that the sunlight can be uniformly collected throughout day time.

The photothermal magnetic drive device of the present embodiment too can be used for a drive source of an electric generator.

[Tenth Embodiment]

In the present embodiment, a trancated cone member 134 is used as the rotary support. The trancated cone member 134 is rotatably attached to a shaft (not shown) and capable of rotating in a horizontal plane.

Thin rectangular heat-sensitive materials 131 are provided on an outer circumferential face of the trancated cone member 134 and arranged in the circumferential direction thereof at regular intervals. Surfaces of the heat-sensitive materials 131 are coated with a black material. Three condensing lenses (half-columnar lenses) 131 are arranged parallel to the heat-sensitive materials 131.

A symbol 139 stands for a magnetic field.

In the present embodiment too, the sunlight is collected and focused by the condensing lenses 138 so as to rotate the trancated cone member in a direction of an arrow shown in FIG. 43 as well as the foregoing embodiments.

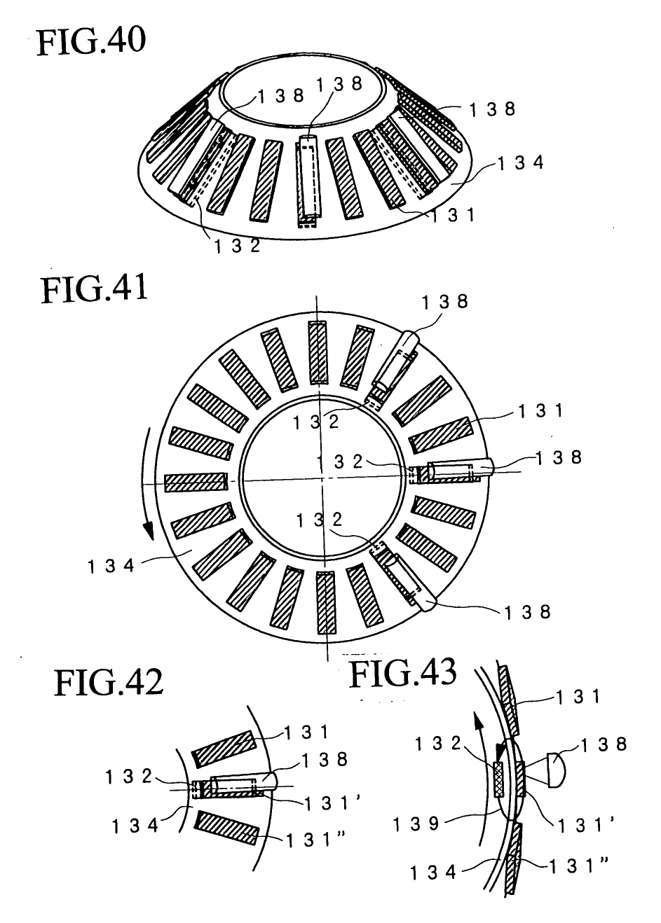

In FIG. 40, the center lens of three lenses 138 is headed for the south, the right lens is headed for the east and the left lens is headed for the west; any of the condensing lenses 138 can focus the sunlight while the sun moves along the ecliptic from east to west, so that the trancated cone member 134 can be rotated throughout day time.

Since the outer circumferential face of the trancated cone member 134 is inclined, the sunlight irradiates the outer circumferential face at the right angle, so efficiency of the drive device can be high.

If a planter (not shown), in which plants have been planted, is mounted on the trancated cone member 134, the sunlight can irradiate the plants, from all directions, throughout day time because the trancated cone member 134 always rotates the trancated cone member 134.

[Eleventh Embodiment]

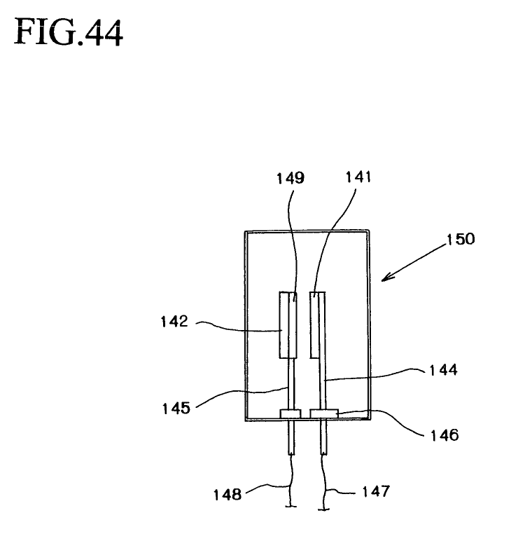

A lead switch including the heat-sensitive material is shown in FIG. 44.

A chip 141 made of the heat-sensitive material is fixed to one end of an elastic piece (support) 144 having electric conductivity; a permanent magnet 142 facing the chip 141 is held by a support section 145. An electric conductive member 149, e.g., a metal plate, is provided on a surface of the permanent magnet 142. A holding section 146 holds the other end of the elastic piece 144. A lead wire 147 is connected to the elastic piece 144; a lead wire 148 is connected to the electric conductive member 149.

When atmosphere temperature is lower than prescribed temperature, the chip 141 is drawn, against the elasticity of the electric conductive member 144, toward the permanent magnet 142, so that the lead wires 147 and 148 are electrically connected; when the atmosphere temperature is higher than the prescribed temperature, magnetization intensity of the chip 141 is lowered, the chip 141 is moved away from the permanent magnet 142 by the elasticity of the electric conductive member 144, so that the lead wires 147 and 148 are electrically disconnected. The lead switch 150 may be effectively used for preventing overheat of a heater, etc..

Note that, the permanent magnet 142 may be provided to the electric conductive member 144, and the chip 141 may be provided to the support section 145.

Note that, in the foregoing embodiments, Ni—Al alloys are used as the heat-sensitive material, but the Ni based alloys can be use as well.

Effects of the Invention

In the present invention, the photothermal magnetic drive device, which is capable of continuously rotation and stepping rotation and which includes the heat-sensitive magnetic materials made of an inexpensive and easy-workable Ni based alloy, can be provided.

In the case of using semiconductor laser means and optical fibers, the drive device can be applied to a micro actuator, which can be remote-controlled without cables.

In the case of using the film-shaped heat-sensitive magnetic materials and a small-sized semiconductor laser means, which is used for writing data on a CD-R/RW, as the photothermal source, the drive device can be micronized.

Besides the laser means, the sunlight and near infrared rays can be used as the photothermal source, so the drive device can by applied to drive devices and electric generator using the sunlight.

What is claimed is

1. A method of driving a photothermal magnetic drive device, which comprises: a support of a non-magnetic material supported rotatably; a plurality of heat-sensitive magnetic materials disposed on said support at intervals in the rotational direction thereof and each consisting of a Ni based alloy (excluding NiFe alloys and NiFeCr alloys) having low-temperature Curie temperature; a magnet disposed facing one of or a plurality of said heat-sensitive magnetic materials, for producing a magnetic field; and a heat collecting unit for spot-controlling heat from a photothermal source to a position deviated from the magnetizing center, by said magnet, on said heat-sensitive magnetic material facing said magnet, comprising the steps of:
providing said photothermal drive device in a low temperature atomosphere, whose temperature is lower than the Curie temperature of said heat-sensitive magnetic materials; and
collecting heat from said photothermal source by said heat collecting unit and supplying the heat to the position deviated from the magnetizing center on said heat-sensitive magnetic material so as to rise temperature of said position, whereby magnetization intensity of said position is lowered and magnetic balance of said heat-sensitive magnetic material is affected so as to draw said heat-sensitive magnetic material in the rotational direction of said support to rotate said support.

2. A photothermal magnetic drive device, comprising:
a support of a non-magnetic material supported rotatably;
a plurality of heat-sensitive magnetic materials disposed on said support at intervals in the rotational direction thereof and each consisting of a Ni based alloy (excluding NiFe alloys and NiFeCr alloys) having low-temperature Curie temperature;
a magnet disposed facing one of or a plurality of said heat-sensitive magnetic materials, for producing a magnetic field; and
a heat collecting unit for spot-controlling heat from a photothermal source to a position deviated from the magnetizing center, by said magnet, on said heat-sensitive magnetic material facing said magnet.

3. The photothermal magnetic drive device according to claim 2, further comprising a photothermal source.

4. The photothermal magnetic drive device according to claim 3, wherein said photothermal source is a laser device or an infrared ray device.

5. The photothermal magnetic drive device according to claims 2, 3 or 4, wherein said Ni based alloy is selected from Ni—Al alloys, Ni—Al—Si alloys, Ni—Ti alloys, Ni—Cr alloys, Ni—Mo alloys and Fe—Ni—Al alloys.

6. The photothermal magnetic drive device according to claims 2, 3 or 4, wherein said Ni based alloy is selected from Ni—Al alloys excluding Ni₃ Al phases.

7. The photothermal magnetic drive device according to one of claims 2-6, wherein surfaces of said heat-sensitive magnetic materials consisting of the Ni based alloy are coated with a black material.

8. The photothermal magnetic drive device according to one of claims 2-7, wherein said heat collecting unit is a light collecting unit including a condensing lens.

9. The photothermal magnetic drive device according to one of claims 2-7, wherein said heat collecting unit is a light collecting unit including optical fibers.

10. The photothermal magnetic drive device according to one of claims 2-9, wherein said support is a circular rotary disk, and said heat-sensitive magnetic materials are provided on one side face of the circular rotary disk and arranged, at fixed intervals, along a circle coaxial to an axis of the circular rotary disk.

11. The photothermal magnetic drive device according to claim 10, wherein said magnet faces an outer face and/or an inner face of said heat-sensitive magnetic material.

12. The photothermal magnetic drive device according to claim 10, wherein said magnet is provided in a plane parallel to said heat-sensitive magnetic materials arranged along said coaxial circle so as to face said heat-sensitive magnetic materials.

13. The photothermal magnetic drive device according to claim 10, wherein said heat-sensitive magnetic materials are fixed to ventilation fins, which are radially provided on one side face of the circular rotary disk.

14. The photothermal magnetic drive device according to one of claims 2-9, wherein said support is a rotary drum, said heat-sensitive magnetic materials are arranged, in a circumferential direction, on an outer face of the rotary drum at fixed intervals, and said magnet is provided in the rotary drum.

15. The photothermal magnetic drive device according to claim 14, wherein a plurality of rows of said heat-sensitive magnetic materials are arranged on the outer face of the rotary drum, and phases of said heat-sensitive magnetic materials of the adjacent rows are shifted in the circumferential direction of the rotary drum.

16. The photothermal magnetic drive device according to claims 14 or 15, wherein said heat-sensitive magnetic materials are diagonally arranged with respect to an axis of the rotary drum.

17. The photothermal magnetic drive device according to one of claims 2-9, wherein said support is formed into a trancated cone, said heat-sensitive magnetic materials are arranged, in a circumferential direction, on an outer face of the trancated cone at fixed intervals, and said magnet is provided in the trancated cone.

18. A production method for a heat-sensitive magnetic material constituting of a Ni based alloy (excluding NiFe alloys and NiFeCr alloys) having low-temperature Curie temperature, comprising the steps of: forming alloy powders by mechanical-alloying Ni powders with metal powders; accommodating said alloy powders in a molding die; and pressurizing and heating the molding die by inputting pulse-electricity so as to sinter said alloy powders.

19. A production method for a heat-sensitive magnetic material constituting of a Ni based alloy (excluding NiFe alloys and NiFeCr alloys) having low-temperature Curie temperature, comprising the steps of: forming alloy powders by mechanical-alloying Ni powders with metal powders; melting said alloy powders in a vacuum furnace so as to form an alloy; and hardening said alloy.

20. A lead switch, comprising:
an elastic conductive piece, which has electric conductivity and whose one end is fixed;
a heat-sensitive magnetic material fixed to the other end of said elastic conductive piece, said heat-sensitive magnetic material constituting of a Ni based alloy (excluding NiFe alloys and NiFeCr alloys) having low-temperature Curie temperature;
a magnet disposed facing said heat-sensitive magnetic material, said magnet producing a magnetic field; and
lead wires respectively connected to said elastic conductive piece and said magnet.

21. A lead switch, comprising:
an elastic conductive piece, which has electric conductivity and whose one end is fixed;
a magnet fixed to the other end of said elastic conductive piece, said magnet producing a magnetic field;
a heat-sensitive magnetic material disposed facing said magnet, said heat-sensitive magnetic material constituting of a Ni based alloy (excluding NiFe alloys and NiFeCr alloys) having low-temperature Curie temperature; and
lead wires respectively connected to said elastic conductive piece and said magnet.
